(19) United States
(12) Patent Application Publication
(10) Pub. No.: US 2026/0311705 A1
(43) Pub. Date: Oct. 8, 2026

(54) SYSTEMS AND METHODS FOR COLLABORATIVE AUDIO AGENTS USING LARGE LANGUAGE MODELS AND RETRIEVAL-AUGMENTED GENERATION

(71) Applicant: Robert Bosch GmbH, Stuttgart (DE)

(72) Inventors: Pongtep ANGKITITRAKUL, Dublin, CA (US); Samarjit DAS, Wexford, PA (US)

(21) Appl. No.: 19/172,716

(22) Filed: Apr. 8, 2025

(51) Int. Cl. G10L 17/26; G06F 16/683

(52) U.S. Cl. CPC G10L 17/26; G06F 16/683

(57) ABSTRACT

System and methods for diagnosing device issues through a chat session addresses the challenge of diagnosing complex audio-related problems. The system includes a Large Language Model (LLM) that serves as an interface between a human user and multiple expert audio models. The system receives an audio recording from a user, executes the LLM to gather additional information, identifies a realm of sound, and selects an expert audio agent specialized in that realm. The audio is processed using retrieval augmented generation (RAG) to determine the likely cause of the issue, which is then communicated to the user. The system enhances problem-solving capabilities by enabling collaboration among specialized agents, thereby improving the efficiency and accuracy of audio diagnostics.

### TECHNICAL FIELD

The present disclosure generally relates to artificial intelligence technologies. In specific embodiments, the present disclosure relates to multi-agent collaboration frameworks for audio applications utilizing large language models and retrieval-augmented generation.

### BACKGROUND

In the evolving landscape of artificial intelligence (AI), significant strides have been made across various sectors, including manufacturing, healthcare, and logistics. These advancements have enabled the creation of systems adept at managing intricate and multifaceted interactions. Despite these developments, the integration of AI within audio applications presents ongoing challenges. Traditional audio systems typically depend on singular agents or models that are tailored to specific tasks, such as sound recognition or audio classification. These systems have limitations in their capacity to manage complex interactions, often necessitating rigid syntax or predefined rules that hinder their adaptability and responsiveness in dynamic environments.

Current solutions in the realm of audio applications predominantly emphasize individual agent systems or machine translation-based multilingual dialog systems. Although these approaches can be effective in certain scenarios, they are accompanied by notable limitations. Systems utilizing automatic machine translation for multilingual interactions are often restricted by language-specific capabilities, failing to address the broader requirement for task coordination and collaboration among multiple specialized agents. Additionally, methods that rely on selecting a single agent based on past performance do not fully exploit the potential of collaborative problem-solving among specialized agents, thereby constraining the system's ability to efficiently address complex tasks.

### SUMMARY

In an embodiment, a method for diagnosing device issues through a chat session utilizes a Large Language Model (LLM) as an interface between a human user and multiple expert audio models. The method comprises receiving an audio recording from a human user, wherein the audio recording is associated with a potential error or problem with a device; executing an LLM to obtain additional information from the user regarding the audio recording; identifying a realm of sound based upon the audio recording and the additional input from the user; selecting an expert audio agent specialized in the identified realm of sound, wherein the expert audio agent is one of a plurality of expert audio agents configured to analyze specific types of audio characteristics in a respective one of the realms of sound; processing the audio recording via the selected expert audio agent utilizing retrieval augmented generation (RAG) to yield data related to a likely cause of the error or problem associated with the audio recording; and executing the LLM to communicate the likely cause of the error or problem output by the selected expert audio agent to the user.

In an embodiment, a computing system for diagnosing device issues through a chat session utilizes a Large Language Model (LLM) as an interface between a human user and multiple expert audio models. The computing system comprises one or more processors programmed to receive an audio recording from a human user, wherein the audio recording is associated with a potential error or problem with a device; execute an LLM to obtain additional information from the user regarding the audio recording; identify a realm of sound based upon the audio recording and the additional input from the user; select an expert audio agent specialized in the identified realm of sound, wherein the expert audio agent is one of a plurality of expert audio agents configured to analyze specific types of audio characteristics in a respective one of the realms of sound; process the audio recording via the selected expert audio agent utilizing retrieval augmented generation (RAG) to yield data related to a likely cause of the error or problem associated with the audio recording; and execute the LLM to communicate the likely cause of the error or problem output by the selected expert audio agent to the user.

In an embodiment, a non-transitory computer-readable medium stores instructions that, when executed by a processor, cause the processor to perform a method comprising receiving an audio recording from a human user, wherein the audio recording is associated with a potential error or problem with a device; executing an LLM to obtain additional information from the user regarding the audio recording; identifying a realm of sound based upon the audio recording and the additional input from the user; selecting an expert audio agent specialized in the identified realm of sound, wherein the expert audio agent is one of a plurality of expert audio agents configured to analyze specific types of audio characteristics in a respective one of the realms of sound; processing the audio recording via the selected expert audio agent utilizing retrieval augmented generation (RAG) to yield data related to a likely cause of the error or problem associated with the audio recording; and executing the LLM to communicate the likely cause of the error or problem output by the selected expert audio agent to the user.

### BRIEF DESCRIPTION OF THE DRAWINGS

FIG. 1 generally illustrates a system for training a neural network, according to an embodiment.

FIG. 2 generally illustrates a computer-implemented method for training and utilizing a neural network, according to an embodiment.

FIG. 3A is a block diagram of the interaction framework of a multi-agent audio system with an LLM supervisor, according to an embodiment.

FIG. 3B is a sequence diagram of interactions between a human user and the system, according to an embodiment.

FIG. 4 is a flow chart diagram of a method for diagnosing audio-related issues using expert agents and LLMs, according to an embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In recent years, the advancement of artificial intelligence (AI) has significantly transformed various industries, including manufacturing, healthcare, and logistics. However, despite these advancements, the integration of AI systems in audio applications remains challenging. Traditional audio systems often rely on singular agents or models that specialize in specific tasks, such as sound recognition or audio classification. These systems are limited in their ability to handle complex, multifaceted interactions and often require rigid syntax or predefined rules, which restrict their adaptability and responsiveness to dynamic environments.

In the field of audio applications, previous developments have primarily focused on individual agent systems or machine translation-based multilingual dialog systems. These approaches, while effective in certain contexts, exhibit several disadvantages. For instance, systems that employ automatic machine translation for multilingual interactions are constrained by language-specific capabilities and do not address the broader need for task coordination and collaboration among multiple expert agents. Similarly, methods that select a single agent based on previous performance fail to leverage the potential of collaborative problem-solving across specialized agents, limiting the system's ability to tackle complex tasks efficiently.

The present system addresses these challenges by introducing a novel multi-agent collaboration framework specifically designed for audio applications. This framework facilitates interaction and cooperation among independent audio expert agents, each specializing in distinct tasks such as audio understanding, manipulation, and generation. By leveraging the capabilities of Large Language Models (LLMs), the system empowers these agents to operate autonomously, utilizing audio and other modalities to communicate, exchange important information, and share knowledge. This collaborative approach enhances efficiency and problem-solving capabilities, positioning agents as experts who can engage in discussions, debates, and guidance for users. The multi-agent system excels at tackling complex, real-time challenges, optimizing resource management, and improving decision-making processes, generating deeper insights and more innovative solutions than a single entity could achieve on its own.

According to embodiments disclosed herein, this disclosure provides the creation of a multi-agent collaboration framework specifically designed for audio applications, which leverages the capabilities of LLMs to enhance communication, decision-making, and knowledge sharing among specialized audio expert agents. This framework introduces an integration of Retrieval-Augmented Generation (RAG) to provide domain-specific knowledge, enabling agents to perform tasks autonomously and efficiently. Unlike previous systems, which often focus on single-agent systems or reinforcement learning in multi-agent environments, this framework emphasizes a collaborative approach where human users and multiple audio expert agents work together to tackle complex tasks. The use of LLMs as a central orchestrator facilitates seamless interaction and task coordination, setting this framework apart by offering a scalable, decentralized solution that optimizes resource management and problem-solving capabilities in real-time audio processing scenarios.

The following description continues with a general introduction to machine learning techniques that are relevant to the methods for utilizing machine learning models, such as those described herein. Next, various embodiments of the architecture and process flow of diagnosing device issues through a chat session utilizing a Large Language Model (LLM) are discussed. The present disclosure then demonstrates the versatility of the methods and systems described herein for incorporation into various devices.

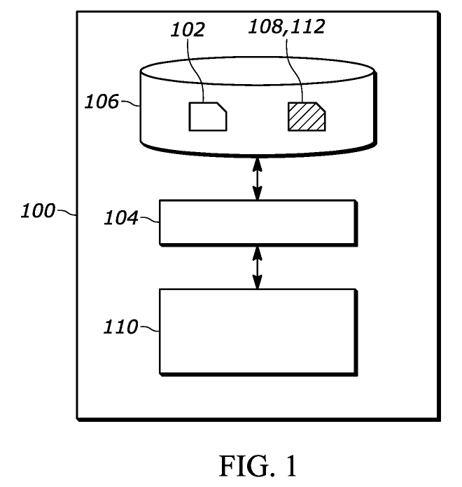

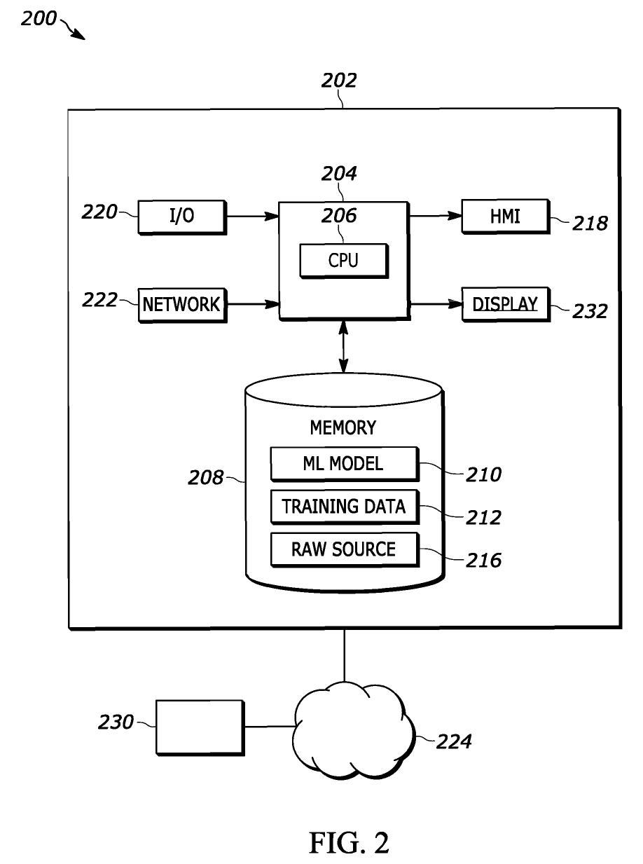

FIG. 1 illustrates a system 100 for training and utilizing a machine learning model, such as a convolutional neural network, according to some embodiments. It should be understood that, while the example embodiments given in the following paragraphs herein with regard to FIGS. 1 and 2 refer to a convolutional neural network, additional embodiments of FIGS. 1 and 2 may be applied to any other type of neural-network-based or non-neural-network-based machine learning model that is configured to be developed, trained, fine-tuned, and/or executed for various applications of audio tracking and interpretation that are further described herein.

In some embodiments, the system 100 may comprise an input interface for accessing training dataset 102 for the convolutional neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the pre-trained convolutional neural network may also each be accessed from a different data storage, e.g., via a different subsystem of the data storage interface 104. Each subsystem may be of a type as is described above for the data storage interface 104. In other embodiments, the data representation 108 of the pre-trained convolutional neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the convolutional neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train and/or fine-tune the convolutional neural network using the training data 102 (e.g., thus generating updated versions of the machine learning model with respect to a first “pre-trained” version of the model). Here, an iteration of the training by the processor subsystem 110 may comprise a forward propagation part and a reverse, or generation, propagation part.

The system 100 may further comprise an output interface for outputting a data representation 112 of the trained convolutional neural network, and this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘pre-trained’ convolutional neural network may during or after the training be replaced, at least in part by the data representation 112 of the trained neural network, in that the parameters of the convolutional neural network, such as weights, hyperparameters, and other types of parameters of convolutional neural networks, may be adapted to reflect the training on the training data 102. This is also illustrated in FIG. 1 by the reference numerals 108 and 112 referring to the same data record on the data storage 106. In other embodiments, the data representation 112 may be stored separately from the data representation 108 defining the ‘pre-trained’ convolutional neural network. In some embodiments, the output interface may be separate from the data storage interface 104, but may in general be of a type as described above for the data storage interface 104.

The system 100 shown in FIG. 1 is one example of a system that may be utilized to train and then subsequently execute the trained machine learning models described herein.

FIG. 2 illustrates a computer-implemented system 200 for training and utilizing a convolutional neural network, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206 and, in some embodiments, a graphics processing unit (GPU). The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 216. The raw source dataset 216 may include raw or unprocessed sensor data that may be representative of an input dataset for a machine learning system. In some examples, the machine learning algorithm 210 may be a convolutional neural network algorithm that is designed to perform a predetermined function. For example, the neural network algorithm may be configured to receive audio segments and text-based event descriptions and operate as agent 306, LLM 304, and/or additionally sub-models 320 described below.

The computer system 202 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with a convolutional neural network algorithm. The training dataset 212 may include a set of source data that has corresponding outcomes or results that the machine learning algorithm 210 tries to duplicate via the learning process.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., annotations) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), the machine learning algorithm 210 may be executed using data that is not in the training dataset 212. The trained machine learning algorithm 210 may be applied to new datasets to generate annotated data.

The machine learning algorithm 210 may be configured to identify a particular feature in the raw source data 216. The raw source data 216 may include a plurality of instances or input dataset for which annotation results are desired. The machine learning algorithm 210 may be programmed to process the raw source data 216 to identify the presence of the particular features. The machine learning algorithm 210 may be configured to identify a feature in the raw source data 216 as a predetermined feature. The raw source data 216 may be derived from a variety of sources. For example, the raw source data 216 may be actual input data collected by a machine learning system. The raw source data 216 may be machine generated for testing the system. As an example, the raw source data 216 may include audio recordings and/or text-based event descriptions that are relevant to a nearby audio environment.

In the example, the machine learning algorithm 210 may then process raw source data 216 and output an indication of which of the text-based event descriptions are supported by audio signals within the audio segment. A machine learning algorithm 210 may generate a confidence level or factor for each output generated. For example, a confidence value that exceeds a predetermined high-confidence threshold may indicate that the machine learning algorithm 210 is confident that the identified source or cause of a sound corresponds to actual source or cause of a sound. A confidence value that is less than a low-confidence threshold may indicate that the machine learning algorithm 210 has some uncertainty that the identified cause or source of the sound is, in fact, the correct one.

As AI systems advance, the nature of human-agent interaction is evolving to accommodate more complex and context-aware commands. Unlike earlier systems that specialized in singular tasks, modern AI-powered systems can handle multifaceted, contextual interactions, understanding nuanced queries without rigid syntax. This shift motivates the development of multi-agent collaboration frameworks in audio applications, where agents can interact and respond intelligently in real time. Like collaborative robotics (cobots), which work alongside humans to enhance safety, creativity, and productivity, multi-agent audio systems integrate AI for more flexible and personalized support. These systems also enable AI-enhanced decision-making, providing real-time insights that allow for dynamic, context-sensitive responses. In autonomous ecosystems, agents self-regulate and learn autonomously, while human operators oversee high-level strategies. This growing sophistication in AI-driven collaboration is driving innovation in industries such as manufacturing, healthcare, and logistics, where complex tasks demand seamless communication and decision-making across multiple agents.

AI agents are playing an increasingly important role in audio applications, autonomously processing and analyzing sounds to achieve tasks such as audio classification, sound recognition, and real-time sound mixing. In environments ranging from factories to nature reserves, these agents can monitor noises, such as machinery hums or wildlife calls, and trigger appropriate actions, like alerting maintenance teams or cataloging animal sounds. By collecting and interpreting audio data, these agents provide valuable insights and can act independently, making them highly effective in sound-based tasks. Different types of AI agents are tailored to handle various audio challenges. Simple reflex agents respond to specific audio inputs based on predefined rules, such as automatically reducing noise when decibel levels rise. Model-based reflex agents go further by evaluating sound patterns to predict potential issues, like detecting subtle changes in factory machinery noise to prevent equipment failure. Goal-based agents, ideal for tasks such as noise cancellation, select the most effective strategies to achieve desired outcomes. Utility-based agents, common in music production, help balance sound quality with artistic preferences, while learning agents continuously improve by analyzing previous sound data, enhancing their performance in dynamic environments. Hierarchical agents, structured in layers, manage complex audio tasks by coordinating different agents, ensuring seamless operations in systems like smart homes, where sound monitoring and playback are handled simultaneously.

Multi-agent collaboration involves the interaction and cooperation of autonomous entities, such as AI agents or collaborative robots, to achieve common goals. In industries like manufacturing, healthcare, and logistics, these agents work together to streamline complex tasks, automate workflows, and manage resources efficiently. Each agent operates independently but shares relevant data to coordinate actions. This distribution of workload enhances productivity, as agents can focus on specialized tasks while contributing to overarching objectives. In audio applications, multi-agent collaboration improves processes such as sound processing, voice recognition, and speech synthesis. Agents in smart environments can collectively optimize microphone placement, reduce background noise, and refine sound quality, leading to clearer communication and more adaptive, responsive audio systems. Despite their potential, multi-agent collaboration frameworks face challenges, including scalability, communication overhead, and coordination issues. As systems grow in complexity, coordinating actions in real time—particularly in non-speech audio applications—becomes problematic. Limited computational resources, difficulties adapting in unfamiliar environments, and security concerns further hinder the efficiency of these systems. Future advancements should focus on developing decentralized, scalable frameworks, improving learning mechanisms for adaptability, and enhancing multi-modal collaboration by integrating audio with other sensory inputs.

Large Language Models (LLMs), like ChatGPT, play a pivotal role in advancing multi-agent collaboration by enhancing communication, decision-making, and knowledge sharing among agents. LLMs can serve as central coordinators or mediators, interpreting and generating natural language instructions that enable agents to better understand complex tasks, collaborate more efficiently, and adapt to changing environments. By facilitating seamless interaction between agents and human operators, LLMs streamline multi-agent workflows, reducing misunderstandings and improving overall coordination. Their ability to process vast amounts of data quickly also supports real-time decision-making, which is crucial in dynamic settings such as autonomous systems or collaborative robots. Moreover, LLMs enable agents to exchange contextual and high-level information using natural language, which can be applied to audio applications like audio signal processing or sound classification. By interpreting commands and coordinating agent actions in a more intuitive manner, LLMs help improve the overall efficiency of collaborative multi-agent systems, allowing them to handle more complex and nuanced tasks. Their adaptability and learning capabilities also make them valuable for future advancements in multi-agent collaboration, helping agents navigate new challenges and environments more effectively.

Retrieval-Augmented Generation (RAG) is an advanced machine learning approach that combines the strengths of retrieval-based models and generative models to enhance information generation and accuracy. While RAG is commonly applied in natural language processing, its application to audio signals opens new possibilities for tasks such as audio classification, sound event detection, and audio generation. By incorporating a retrieval mechanism, RAG can access a vast repository of reference sounds, enabling it to generate more accurate and contextually relevant outputs when processing audio. For instance, in sound event detection, RAG can retrieve similar past audio events from a database, improving the system's ability to classify or understand current signals more effectively. This combination of retrieval and generation can lead to better performance in applications like environmental sound monitoring, audio creation, or even medical signal analysis, where precise and context-aware processing of audio is crucial. Rather than relying solely on model-based or data-driven approaches to solve complex user queries, the present disclosure proposes incorporating LLMs as a powerful module. LLMs offer broad knowledge and general solutions, working alongside specialized generative AI agents focused on specific tasks. This combination enhances the flexibility and adaptability of solutions, improving overall efficiency and delivering more insightful and comprehensive responses.

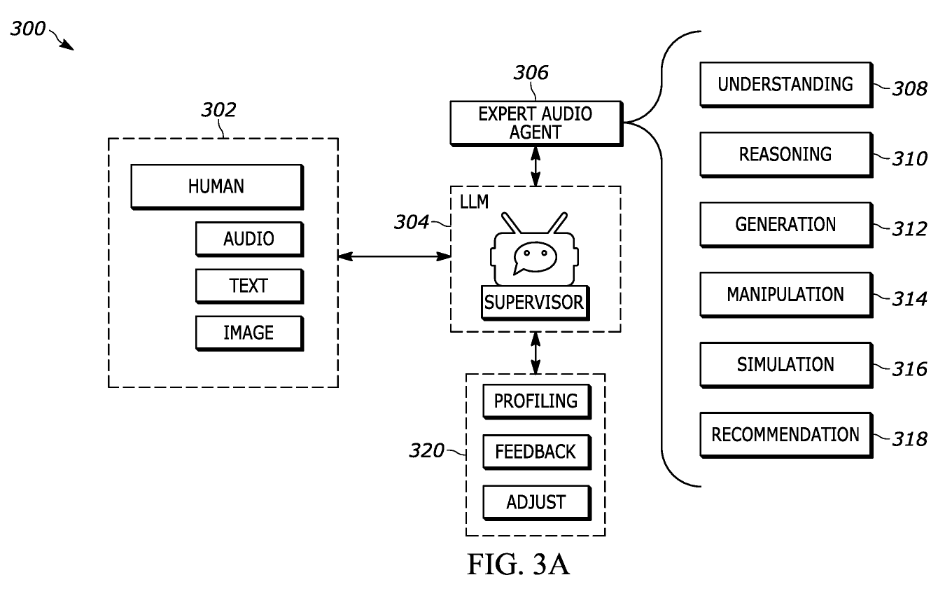

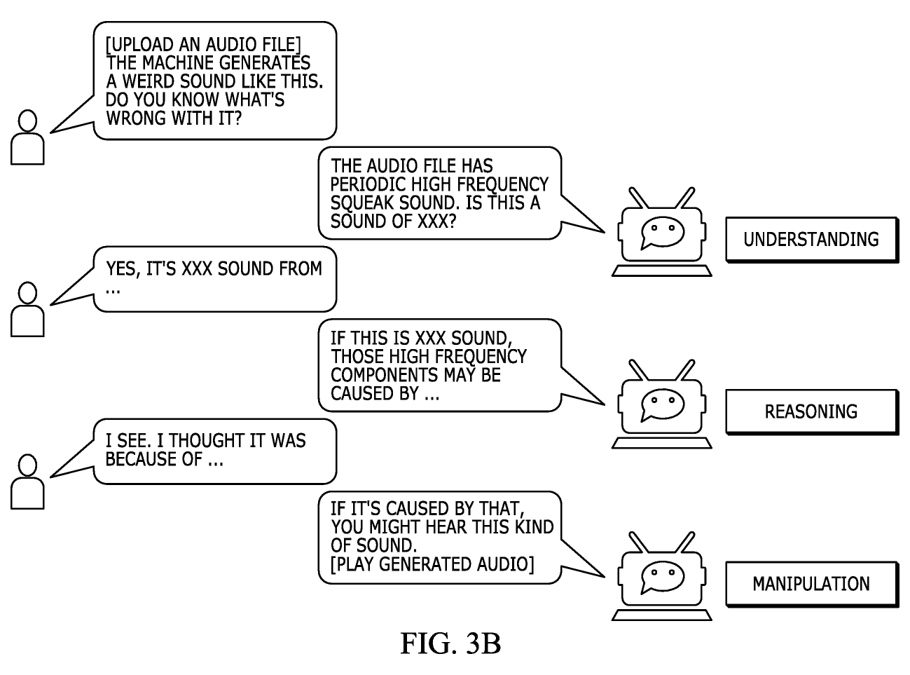

Referring to FIG. 3A, a system 300 for diagnosing device issues through a chat session utilizing a Large Language Model (LLM) is illustrated. The system 300 can operate using the structures and systems described above with reference to FIGS. 1-2.

The system 300 can include one or more several different types of inputs 302. The input serves as the initial point of interaction between the user and the system, encompassing a variety of data types that the user can provide to facilitate the diagnosis of device issues. These inputs can include audio recordings, text descriptions of audio events, and images corresponding to audio events, each offering unique insights into the nature of the problem at hand. Audio recordings can include direct captures of sound that may indicate a malfunction or irregularity in a device, such as unusual noises from a machine or distorted audio output from a speaker. Users can record these sounds using a microphone or a recording device and submit them to the system for analysis.

Text descriptions of audio events provide a narrative or contextual explanation of the audio-related issue. Users may describe the characteristics of the sound, such as its frequency, duration, or any patterns they have observed. This textual input can be particularly useful when the user is unable to capture the audio directly or when additional context is needed to understand the problem fully. By providing a detailed description, users help the system to better interpret the audio data and identify potential causes of the issue.

Images corresponding to audio events can also be submitted as input, offering a visual representation of the environment or device associated with the audio problem. For example, a user might provide a photograph of a machine emitting a strange noise, highlighting specific components that could be malfunctioning. These images can help the system to correlate visual cues with audio data, enhancing the overall analysis. Users can upload these images through an interface, where they are processed alongside audio and text inputs. Once the inputs are received, the supervisor agent 304 utilizes the LLM to integrate and analyze the data, determining the source or cause of the error or problem exemplified by the audio. This comprehensive approach ensures that the system considers all available information, leading to more accurate and effective diagnostics.

To do so, the system 300 has three core modules (or machine-learning models): a supervisor agent 304, expert agents 306, and retrieval augmented generation (RAG).

The supervisor agent 304, or orchestrator, acts as the high-level brains and orchestrator of the system 300, leveraging an LLM to facilitate seamless communication and coordination among various expert agents and the user. The supervisor agent 304 can act as a ML model 210. Acting as an intelligent intermediary, the supervisor agent 304 interprets user inputs, determines the context and nature of the problem, and orchestrates the workflow by delegating tasks to the appropriate expert agents. It serves as the central hub for knowledge sharing, ensuring that each agent receives the necessary information to perform its specialized function. By utilizing the LLM's capabilities, the supervisor agent can break down complex tasks into manageable subtasks, distribute these tasks among the expert agents, and synthesize their outputs into a coherent response for the user. This dynamic role allows the supervisor agent to adapt to evolving conditions and unforeseen challenges, enhancing the system's overall efficiency and effectiveness in diagnosing and resolving device issues.

Expert agents 306 are specialized components within the system, each designed to handle specific tasks related to audio processing and analysis. These agents 306 can operate as ML models 210. These agents possess domain-specific expertise, enabling them to perform functions such as audio understanding, manipulation, generation, simulation, and recommendation. For instance, an audio understanding agent might focus on interpreting the semantic content of audio inputs, while a manipulation agent could modify audio characteristics to meet certain criteria. By operating autonomously within their areas of specialization, expert agents contribute to a collaborative problem-solving environment where their combined efforts lead to more accurate and insightful diagnoses. The system's architecture allows these agents to work in parallel, sharing relevant data and insights through the supervisor agent, which optimizes resource management and enhances the system's ability to tackle complex, real-time audio challenges.

RAG enhances the expert agents' ability to access and utilize domain-specific knowledge. RAG combines the strengths of retrieval-based models and generative models to provide more accurate and contextually relevant outputs. In the context of audio processing, RAG enables expert agents to retrieve similar past audio events or reference sounds from a vast repository (e.g., 208), improving their ability to classify or understand current signals. This retrieval mechanism ensures that the agents have access to the most pertinent information, which is then used to generate more precise analyses and recommendations. By integrating RAG into the workflow, the system can deliver more comprehensive and insightful responses to user queries, ultimately leading to more effective problem resolution and enhanced user satisfaction.

In embodiments, the supervisor agent 304 acts as an intelligent intermediary that facilitates communication, coordination, and decision-making among multiple agents. Leveraging LLMs, the module enhances the collective capabilities of both human and artificial agents, serving as a central hub for knowledge sharing, interaction, and task execution. The LLM enables natural language communication, allowing seamless information exchange between agents and humans, making interactions more intuitive. It also functions as a dynamic repository of knowledge, providing agents with access to vast amounts of data and expertise for problem-solving and decision making. Furthermore, LLMs support task coordination by interpreting complex requirements, breaking them down into manageable subtasks, and distributing these tasks among the expert agents 306 for optimized collaborations. Their contextual understanding ensures coherence in multi-agent interactions, while role assignment capabilities allow LLMs to delegate tasks to the most qualified agents, improving system performance. Additionally, LLMs enable adaptive decision-making, allowing agents to adjust strategies in response to evolving conditions or unforeseen challenges. By interpreting human queries and translating them into agent actions, LLMs guide agents in task completion, using prompt templates to extract knowledge from past interactions to inform each agent's tasks. This creates a more flexible, robust, and efficient collaborative environment, where the supervisor agent not only orchestrates the workflow but also continuously learns and adapts to enhance the system's overall effectiveness in addressing complex audio-related challenges.

In operation, the supervisor agent 304 can communicate with the user about general aspects of the sound that the user wishes to learn more information about. For example, the user may submit the input, and the supervisor agent 304 can process this input and ask for more feedback about the sound. For example, the supervisor 304 may ask the user to explain what type of device the sound is from, how often the sound happens, if there were any known causes to the sound, and the like. The supervisor agent 304 can then enlist the help of one or more expert agents 306 for sub-processing that are not suited for the LLM itself.

The expert agents are specialized components within the multi-agent framework, each equipped with the tools and knowledge necessary to excel in their respective domains. These agents are designed to handle specific tasks related to audio processing and analysis, contributing to a collaborative environment where their combined efforts lead to more accurate and insightful diagnoses. As shown in FIG. 3A, the following features highlight the capabilities of expert agents: understanding, reasoning, generation, manipulations, simulation, and recommendation.

Understanding 308 refers to the capability of the expert agent to interpret audio signals and extract their semantic meaning, bridging the gap between sound and understanding. These models analyze both the auditory features (e.g., pitch, timbre, and rhythm) and the semantic content embedded within the audio. For instance, in a real-world scenario, an understanding agent could analyze a recording of a malfunctioning machine to identify specific sound patterns indicative of mechanical issues, such as a high-pitched squeal suggesting a worn-out bearing.

Reasoning 310 extends beyond basic audio recognition or classification to tasks such as understanding context, identifying speaker intent, and making logical deductions from audio signatures. This involves analyzing, interpreting, and drawing inferences from audio signals, requiring the model to understand the context and meaning of sounds. For example, a reasoning agent might evaluate the audio environment of a factory floor to deduce that a sudden increase in noise levels is due to a malfunctioning conveyor belt, rather than normal operational sounds.

Generation 312 involves creating or synthesizing new sounds from scratch, such as generating environmental sounds or music, using techniques like Generative Adversarial Networks (GANs) or diffusion-based models. In practice, a generation agent could be used to simulate the sound of a machine operating under optimal conditions, providing a reference for comparison against actual recordings to identify discrepancies and potential issues.

Manipulations 314 refer to the process of modifying existing audio samples, or audio that is received by the user, encompassing tasks such as sound editing, audio enhancement, and style transfer. This involves altering the characteristics of audio—such as pitch, timbre, or rhythm—while preserving the essence or signature of the original sound. For example, a manipulation agent might be employed to filter out background noise from a recording of a machine, allowing for clearer analysis of the machine's operational sounds.

Simulation 316 refers to the creation of realistic auditory experiences that closely mimic real-world sounds and environments. This includes simulating diverse soundscapes, environmental noises, and complex acoustic interactions, such as echoes, reverberations, or directional sound effects. A simulation agent could be used to recreate the acoustic environment of a manufacturing plant, enabling engineers to test how changes in machinery placement might affect sound propagation and noise levels.

Recommendation 318 involves analyzing user queries, audio features, and contextual cues to deliver personalized and relevant audio content. This process assesses factors such as user preferences, interaction history, and acoustic characteristics of audio—such as genre, tempo, and mood. For example, a recommendation agent might suggest maintenance actions based on the analysis of audio recordings from a machine, advising on parts that may need replacement or adjustments to improve performance.

In embodiments, the audio expert agents can leverage audio foundation models, which serve as robust starting points for a variety of audio-related tasks. These foundation models can be pre-trained on extensive datasets, encompassing a wide range of audio types and characteristics, thereby equipping the expert agents with a comprehensive understanding of audio signals. For tasks such as understanding, these models can be fine-tuned to recognize and interpret specific audio patterns, enabling the agents to accurately identify and classify sounds based on their semantic content. For instance, an audio understanding agent might utilize a foundation model trained on diverse environmental sounds to detect anomalies in industrial noise, such as identifying a high-pitched whine that indicates a potential mechanical failure. In the realm of audio generation, foundation models can be employed to synthesize new sounds that are contextually relevant and acoustically rich. By using techniques like Generative Adversarial Networks (GANs) or diffusion models, these agents can create realistic audio simulations that mimic real-world environments or generate entirely new soundscapes for applications like virtual reality or gaming. The adaptability of foundation models allows expert agents to be fine-tuned with domain-specific datasets, ensuring that they are not only proficient in general audio tasks but also optimized for specialized applications, thereby improving accuracy and effectiveness in real-world scenarios. This integration of foundation models into the workflow of audio expert agents facilitates a more efficient and precise approach to audio processing, ultimately enhancing the system's overall capability to address complex audio challenges.

Each of these expert agent features allow the system 300 to tackle complex audio-related challenges with precision and efficiency. By leveraging these capabilities, the system can provide deeper insights and more innovative solutions than a single entity could achieve on its own.

As explained above, RAG can enhance the capabilities of audio expert agents across various tasks, including understanding, reasoning, generation, manipulation, simulation, and recommendation. By integrating retrieval mechanisms with generative models, RAG provides agents with access to a vast repository of reference sounds and contextual information, enabling more accurate and contextually relevant outputs.

For audio understanding, RAG can retrieve similar past audio events from a database, aiding agents in better analyzing new audio inputs. For example, in a factory setting, an understanding agent might use RAG to compare a current recording of machinery noise with historical data, identifying patterns that suggest a specific type of mechanical wear or failure.

In audio reasoning, RAG supports agents in drawing logical inferences by providing access to related audio samples or contextual data. For instance, a reasoning agent tasked with diagnosing a complex audio issue in a concert hall might retrieve past recordings of similar acoustic environments to deduce the cause of an unexpected echo or feedback loop.

For audio generation, RAG can enhance the creative process by retrieving sound samples that match desired characteristics, ensuring the generated audio aligns with specific requirements. In a real-world scenario, a generation agent could use RAG to produce a soundscape for a virtual reality game, drawing on a library of natural sounds to create an immersive forest environment.

In audio manipulation, RAG can provide reference sound clips or effects that serve as guides for precise alterations. For example, a manipulation agent working on a podcast might retrieve high-quality audio samples to guide the enhancement of voice clarity and the reduction of background noise, ensuring a professional sound quality.

For audio simulation, RAG can retrieve real-world audio data or environmental recordings, which serve as templates for creating highly realistic and immersive soundscapes. A simulation agent could use RAG to model the acoustics of a new architectural design, retrieving data from similar structures to predict how sound will propagate within the space.

In audio recommendation, RAG analyzes user preferences and past interactions to retrieve similar or complementary audio content, tailoring suggestions to enhance user engagement. For instance, a recommendation agent might use RAG to suggest maintenance actions for a vehicle based on audio recordings of engine sounds, advising on potential issues and preventive measures based on historical data of similar vehicles.

By leveraging RAG, audio expert agents can perform their tasks with greater precision and contextual awareness, ultimately leading to more effective problem-solving and user satisfaction.

In embodiments, as shown in FIG. 3A, the supervisor agent, powered by an LLM, can incorporate various sub-models 320 to enhance its functionality and improve the overall efficiency of the system. These sub-models include feedback integration, logging and monitoring, data versioning, response generation, context enrichment, and query planning. Each of these sub-models can play a crucial role in optimizing the system's performance and ensuring accurate and effective diagnostics.

Feedback integration is a sub-model that allows the supervisor agent to continuously learn and adapt based on user interactions and outcomes. By collecting feedback from users regarding the accuracy and usefulness of the system's responses, the supervisor agent can refine its algorithms and improve future interactions. This iterative learning process helps the system to become more adept at diagnosing issues and providing relevant solutions over time.

Logging and monitoring involve maintaining the system's reliability and performance. The supervisor agent can track and record all interactions, including user inputs, system responses, and the actions of expert agents. This data is invaluable for identifying patterns, diagnosing system errors, and ensuring compliance with operational standards. Monitoring also enables real-time oversight of the system's activities, allowing for prompt intervention if any anomalies or inefficiencies are detected.

Data versioning involves managing the evolution of the system's knowledge base. As new data is integrated and models are updated, the supervisor agent can maintain different versions of datasets and algorithms. This ensures that the system can revert to previous versions if necessary and provides a clear history of changes for auditing and improvement purposes.

Response generation is a sub-model that focuses on crafting coherent and contextually appropriate replies to user queries. The supervisor agent utilizes the LLM's natural language processing capabilities to synthesize information from expert agents and present it in a user-friendly manner. This involves selecting the most relevant data, structuring it logically, and ensuring that the language is clear and concise.

Context enrichment enhances the system's ability to understand and interpret user inputs by incorporating additional contextual information. The supervisor agent can draw on historical data, user profiles, and environmental factors to provide a more comprehensive analysis of the problem. This enriched context allows the system to tailor its responses more precisely to the user's specific situation.

Query planning involves strategizing the sequence and nature of interactions with the user and expert agents. The supervisor agent can determine the most efficient path to gather necessary information, engage the appropriate expert agents, and deliver a solution. This planning ensures that the system operates smoothly and minimizes the time and effort required to resolve issues.

By integrating these sub-models, the supervisor agent can perform its tasks more effectively, providing a robust and adaptive framework for diagnosing and resolving device issues through a collaborative multi-agent system.

Referring to the system 300 of the FIG. 3A, the expert agents are designed not only to operate autonomously in their specialized domains but also to collaborate and share information with other agents to enhance their performance. This exchange of knowledge and insights allows agents to leverage the collective expertise of the system, leading to more accurate and efficient task execution. For instance, an audio understanding agent might receive contextual data from a reasoning agent that has analyzed the broader environment in which a sound anomaly occurred, providing additional clues that refine the understanding agent's analysis. Similarly, a generation agent tasked with creating a soundscape might incorporate feedback from a manipulation agent that has adjusted audio samples for clarity and quality, ensuring the generated audio meets specific standards. This collaborative approach enables agents to cross-reference findings, validate hypotheses, and integrate diverse perspectives, ultimately leading to more comprehensive solutions. By utilizing shared knowledge, expert agents can adapt to complex scenarios, address multifaceted challenges, and optimize resource management, thereby enhancing the system's overall capability to tackle real-world audio problems with precision and insight. This interconnectedness fosters a dynamic and responsive environment where agents continuously learn from each other, improving their individual and collective performance over time.

Additionally, as explained above, in the multi-agent framework, multiple audio experts or agents can collaborate to accomplish complex tasks by leveraging the power of LLMs. These LLMs act as central orchestrators, facilitating seamless communication and coordination among the agents, enabling them to work together more effectively. By interpreting and generating natural language instructions, LLMs allow agents to better understand complex tasks and collaborate efficiently, adapting to changing environments and task requirements. This collaborative approach is particularly beneficial in scenarios where tasks are too intricate for a single agent to handle alone, such as diagnosing multifaceted audio issues or generating sophisticated soundscapes. For example, in a scenario where a machine's operational sound needs to be analyzed, an understanding agent might identify the sound patterns, while a reasoning agent deduces potential causes, and a manipulation agent enhances the audio for clarity. The LLM facilitates this collaboration by ensuring that each agent receives the necessary information and context to perform its role effectively, synthesizing their outputs into a coherent solution. This synergy not only enhances the problem-solving capabilities of the system but also optimizes resource management, allowing the agents to deliver more innovative and accurate solutions than they could individually. Through the power of LLMs, the multi-agent system becomes a dynamic and adaptive entity, capable of tackling complex audio challenges with precision and insight.

To better illustrate the use of the system 300, FIG. 3B shows a sequence of interactions between a human user and the system according to an embodiment. Here, the Understanding 302, Reasoning 310, and Manipulation 314 agents are utilized, however it should be understood that any or all of the agents described above can be used. The figure illustrates how these components collaborate to diagnose and address audio-related issues presented by the user.

First, the user uploads an audio file and posits the LLM with the following input: "The machine generates a weird sound like this. Do you know what's wrong with it?" The LLM receives this input and begins to work. It first enlists Understanding 302. This component analyzes the audio file uploaded by the user, identifying specific characteristics such as periodic high-frequency squeak sounds. Understanding 302 interprets these auditory features to provide initial insights into the nature of the sound. Via the LLM, the Understanding then asks if the sound corresponds to a known type, such as "xxx."

Once the user confirms that the sound is the sound of an "xxx", the LLM enlists the Reasoning model 306. Reasoning 306 follows Understanding 308 by evaluating the context and potential causes of the identified sound characteristics. The process considers the high-frequency components detected by Understanding 308 and suggests possible sources or conditions that might lead to such audio features. Reasoning 306 extends the analysis by drawing logical inferences from the audio data, helping the user to understand the underlying issues. The LLM might respond again back to the user such as "If this is xxx sound, those high frequency components might be cause by ..."

The user sees this output by the LLM, and responds with his/her own theory of the noise. For example, the user might say "I see. I thought it was because of ..." The LLM can treat this as an opportunity to enlist Manipulation model 306. Manipulation 306 is tasked with generating audio based on the analysis provided by Understanding 308 and Reasoning 310. This component offers a simulation of the sound that might be heard if the identified cause is accurate, allowing the user to compare the generated audio with the original sound. Manipulation 306 enhances the diagnostic process by providing a tangible reference for the user, facilitating a deeper understanding of the audio problem. The generated audio may be played to the user via the user interface.

In another example of a real-world scenario, let's say a user encounters an unusual noise emanating from their coffee maker and seeks assistance from the system 300. The user records the noise and submits it to the supervisor agent 304. Upon receiving the audio input, the supervisor agent first engages the Understanding expert agent 308 to analyze the sound's characteristics, such as frequency and rhythm, to identify any patterns indicative of common issues in coffee makers. The Understanding agent might detect a repetitive grinding noise, suggesting a potential mechanical problem. Next, the supervisor agent enlists the Reasoning expert agent 310 to evaluate the context and possible causes of the noise, considering factors like the coffee maker's operational history and typical failure modes. The Reasoning agent might deduce that the noise could be due to a misaligned grinder or a clogged water line. To provide a more comprehensive analysis, the supervisor agent then calls upon the Manipulation expert agent 314 to enhance the audio recording, filtering out background noise to isolate the coffee maker's sound more clearly. This refined audio allows for a more accurate assessment of the issue. Finally, the supervisor agent synthesizes the insights from these expert agents and communicates a likely diagnosis to the user, suggesting specific components to inspect or actions to take, such as cleaning the grinder or checking the water line, thereby helping the user address the problem effectively.

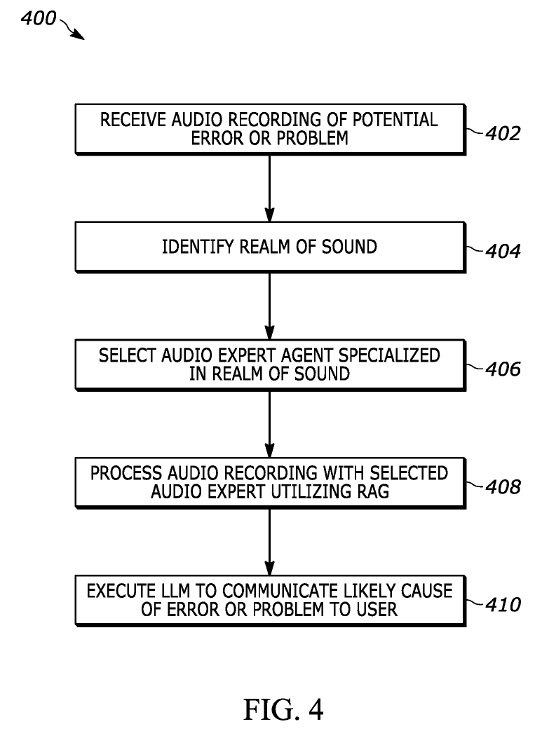

FIG. 4 is a method 400 for diagnosing device issues through a chat session utilizing an LLM as an interface between a human user and multiple expert audio models, according to an embodiment. The method can be carried out and executed using the structure illustrated in FIGS. 1-2, for example the computing system 202. At 402, the computing system 202 (or one or more processors thereof) receives an audio recording from a human user. The audio recording is associated with a potential error or problem with a device. For example, it can be a screeching, grinding, etc. of an appliance, work piece, robot, or the like.

At 404, an LLM (e.g., 304) is executed to obtain additional information from the user regarding the audio recording. For example, the LLM can query the user for what device the sound emanates from, when the sound was generated, what obvious conditions were present during the sound being emitted, or the like. These additional inputs can be general, and can aid the LLM in determining which expert agent to consult.

At 406, the LLM identifies a realm of sound based upon the audio recording and the additional input from the user. The realm of sound can be referred to as a general classification of the sound, for example what type of device the sound emanates from. At 408, the LLM selects an expert audio agent specialized in the identified realm of sound. For example, in the example where the realm of sound has to do with a coffee machine, the expert audio agent selected is one that is an expert in coffee machine sounds. The expert audio agent is one of a plurality of expert audio agents configured to analyze specific types of audio characteristics in a respective one of the realms of sound.

At 408, the expert audio agent processes the audio recording utilizing retrieval augmented generation (RAG) to yield data related to a likely cause of the error or problem associated with the audio recording. This can be communicated to the LLM. Then, at 410, the LLM communicates the likely cause of the error or problem output by the selected expert audio agent to the user. This form of communication can be via a Chabot, or other connected HMI.

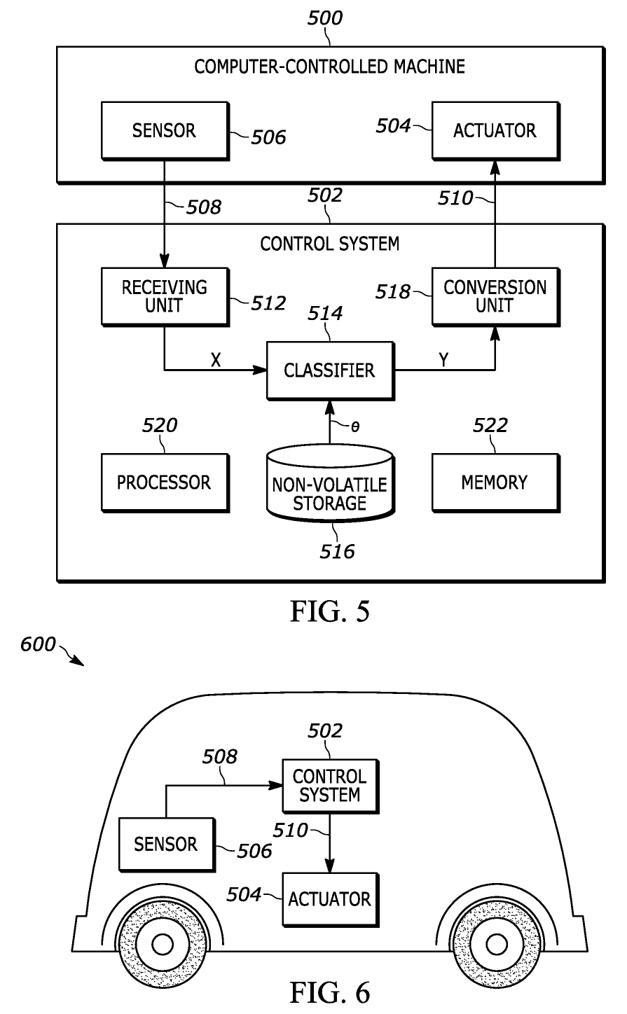

The methods and systems disclosed herein can be used in many different applications. This section provides some practical applications of the proposed system. FIG. 5 illustrates a schematic diagram of an interaction between a computer-controlled machine 500 and a control system 502, according to an embodiment. FIGS. 6-11 illustrate various exemplary settings in which the control system 502 can be implemented.

Referring to FIG. 5, computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. The sensor 506 may be one or more of the sensors described above; non-limiting examples of sensor 506 include microphone, camera, video, radar, LiDAR, ultrasonic and motion sensors. In one embodiment, the sensor 506 is a microphone configured to generate audio signals of an environment within or proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine-learning algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more machine-learning algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the machine-learning algorithms and/or methodologies as disclosed herein. Non-volatile storage 516 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The models and teachings provided herein can be deployed and utilized in a plurality of settings. FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more microphones, video sensors, cameras, radar sensors, ultrasonic sensors, LiDAR sensors, and/or position sensors (e.g. GPS). One or more of the one or more specific sensors may be integrated into vehicle 600. In the context of sign-recognition and processing as described herein, the sensor 506 is a camera mounted to or integrated into the vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect errors or problems with sounds emanating from the vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects, for example.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

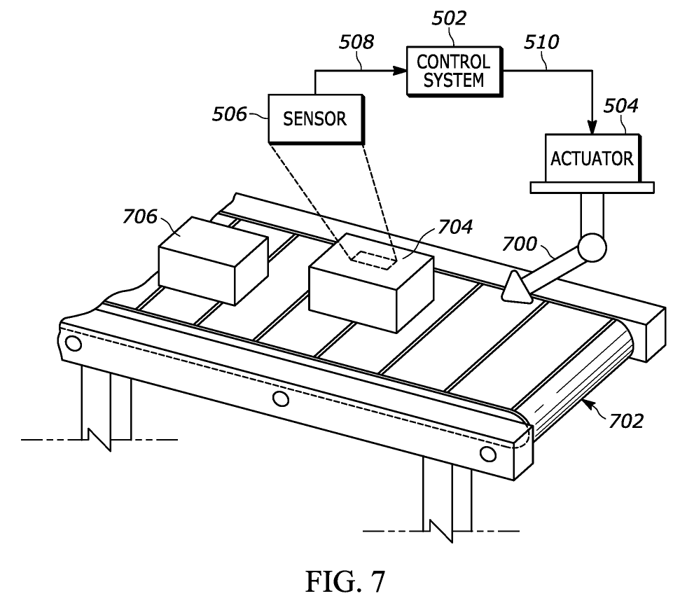

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

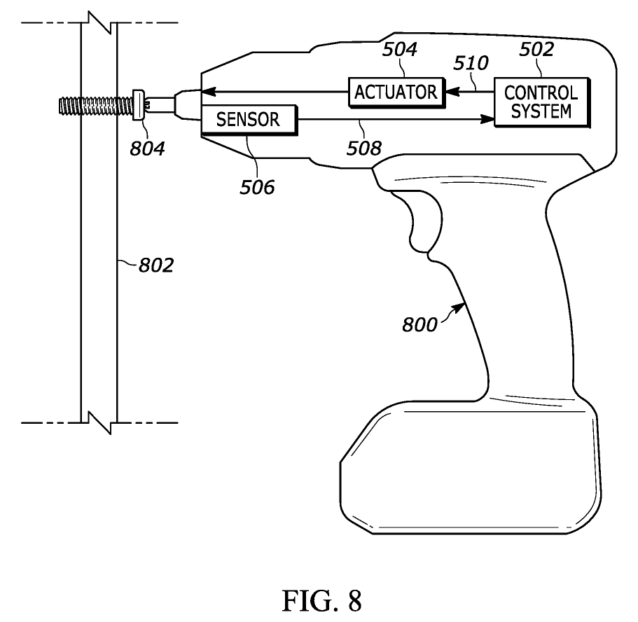

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

In another embodiment, the sensor 506 is a microphone configured to generate one-dimensional sound data associated with the power tool 800 as it is driving fastener 804 into work surface 802. Classifier 514 may be configured to determine a torque of the motor of the tool 800 by converting the sound emitted by the tool into a torque signal, according to the disclosure provided above.

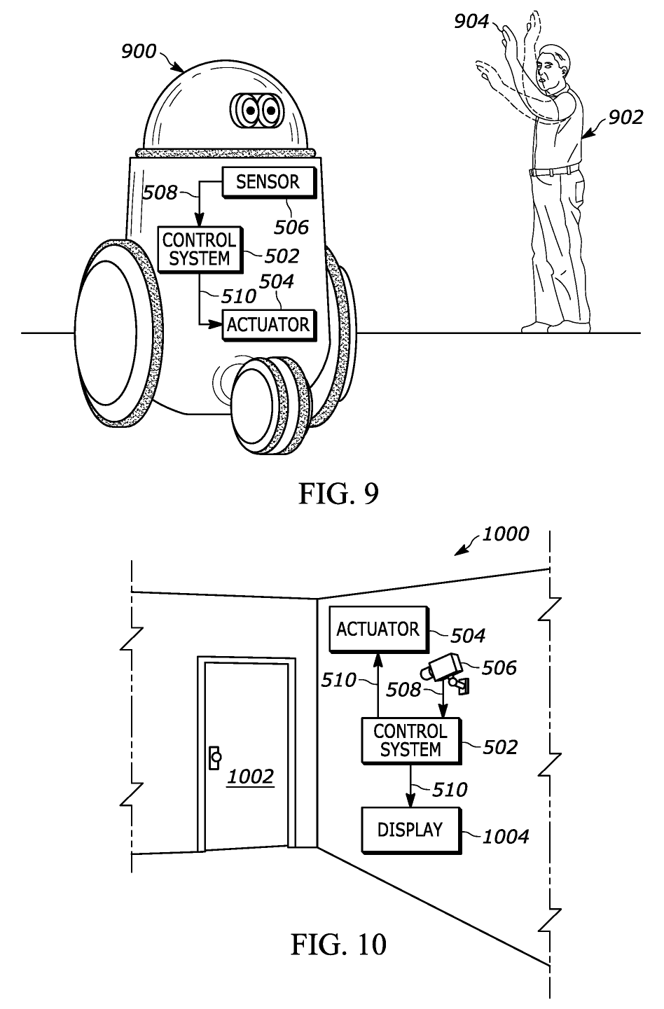

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person’s face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

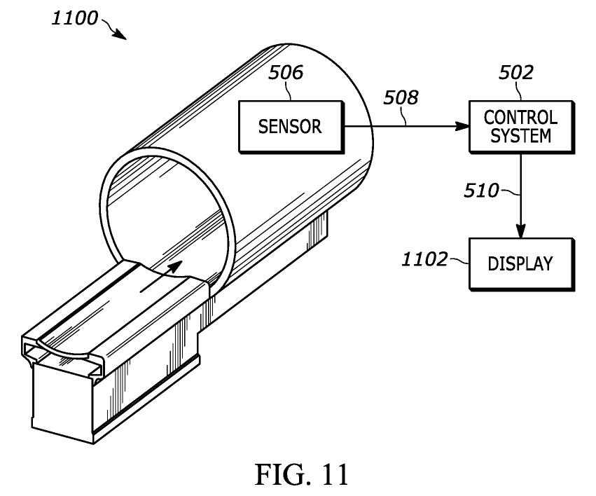

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

In this specification the term “mechanism” is used broadly to refer to a software-based system, subsystem, or process that is programmed to perform one or more specific functions. Generally, a mechanism (e.g., self-attention mechanism) will be implemented as one or more software modules or components, installed on one or more computers in one or more locations. In some cases, one or more computers will be dedicated to a particular mechanism; in other cases, multiple mechanisms can be installed and running on the same computer or computers. References to a multi-head self-attention mechanism can also be referred to as a multi-head self-attention machine-learning model.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for diagnosing device issues through a chat session utilizing a Large Language Model (LLM) as an interface between a human user and multiple expert audio models, comprising:
receiving an audio recording from a human user;
executing an LLM to obtain additional information from the user regarding the audio recording;
identifying a realm of sound based upon the audio recording and the additional input from the user;
selecting an expert audio agent specialized in the identified realm of sound, wherein the expert audio agent is one of a plurality of expert audio agents configured to analyze specific types of audio characteristics in a respective one of the realms of sound;
processing the audio recording via the selected expert audio agent utilizing retrieval augmented generation (RAG) to yield data related to a likely source of the audio in the audio recording; and
executing the LLM to communicate the likely source of the audio output by the selected expert audio agent to the user.

2. The method of claim 1, wherein the audio recording is associated with a potential error or problem with a device, the method further comprising:
executing the expert audio agent to provide recommendations or solutions to the user for addressing the likely cause of the error or problem with the device; and
communicating the recommendations or solutions to the user via the LLM.

3. The method of claim 1, further comprising:
collaborating, via the LLM, tasks between multiple of the plurality of expert audio agents to accomplish tasks.

4. The method of claim 1, wherein the plurality of expert audio agents each specialize in respectively different functionalities including, but not limited to, reasoning, manipulation, and analysis.

5. The method of claim 1, wherein the selected expert audio agents includes a plurality of selected expert audio agents, wherein each selected expert audio agent specializes in a respectively different functionality.

6. The method of claim 5, wherein the step of processing the audio recording includes exchanging information or knowledge between the plurality of selected expert audio agents.

7. The method of claim 6, wherein the LLM facilitates the exchanging of information or knowledge between the plurality of selected expert audio agents.

8. The method of claim 1, wherein the processing of the audio recording via the expert audio agents involves utilizing the RAG to access a repository of stored reference sounds and contextual information, thereby enhancing the agents' ability to generate more accurate and contextually relevant outputs in diagnosing the likely cause of the error or problem associated with the audio recording.

9. A computing system for diagnosing device issues through a chat session utilizing a Large Language Model (LLM) as an interface between a human user and multiple expert audio models, the computing system comprising:
one or more processors programmed to:
receive an audio recording from a human user, wherein the audio recording is associated with a potential error or problem with a device;
execute an LLM to obtain additional information from the user regarding the audio recording;
identify a realm of sound based upon the audio recording and the additional input from the user;
select an expert audio agent specialized in the identified realm of sound, wherein the expert audio agent is one of a plurality of expert audio agents configured to analyze specific types of audio characteristics in a respective one of the realms of sound;
process the audio recording via the selected expert audio agent utilizing retrieval augmented generation (RAG) to yield data related to a likely cause of the error or problem associated with the audio recording; and
execute the LLM to communicate the likely cause of the error or problem output by the selected expert audio agent to the user.

10. The computing system of claim 9, wherein the processor is further programmed to:
execute the expert audio agent to provide recommendations or solutions to the user for addressing the likely cause of the error or problem with the device; and
communicate the recommendations or solutions to the user via the LLM.

11. The computing system of claim 9, wherein the processor is further programmed to:
collaborate, via the LLM, tasks between multiple of the plurality of expert audio agents to accomplish tasks.

12. The computing system of claim 9, wherein the plurality of expert audio agents each specialize in respectively different functionalities including, but not limited to, reasoning, manipulation, and analysis.

13. The computing system of claim 9, wherein the selected expert audio agents includes a plurality of selected expert audio agents, wherein each selected expert audio agent specializes in a respectively different functionality.

14. The computing system of claim 13, wherein the processing of the audio recording includes exchanging information or knowledge between the plurality of selected expert audio agents.

15. The computing system of claim 14, wherein the LLM facilitates the exchanging of information or knowledge between the plurality of selected expert audio agents.

16. The computing system of claim 9, wherein the processing of the audio recording via the expert audio agents involves utilizing the RAG to access a repository of stored reference sounds and contextual information, thereby enhancing the agents' ability to generate more accurate and contextually relevant outputs in diagnosing the likely cause of the error or problem associated with the audio recording.

17. A non-transitory computer-readable medium storing instructions that, when executed by a processor, cause the processor to perform a method comprising:
receiving an audio recording from a human user, wherein the audio recording is associated with a potential error or problem with a device;
executing an LLM to obtain additional information from the user regarding the audio recording;
identifying a realm of sound based upon the audio recording and the additional input from the user;
selecting an expert audio agent specialized in the identified realm of sound, wherein the expert audio agent is one of a plurality of expert audio agents configured to analyze specific types of audio characteristics in a respective one of the realms of sound;
processing the audio recording via the selected expert audio agent utilizing retrieval augmented generation (RAG) to yield data related to a likely cause of the error or problem associated with the audio recording; and
executing the LLM to communicate the likely cause of the error or problem output by the selected expert audio agent to the user.

18. The non-transitory computer-readable medium of claim 17, wherein the selected expert audio agents includes a plurality of selected expert audio agents, wherein each selected expert audio agent specializes in a respectively different functionality.

19. The non-transitory computer-readable medium of claim 18, wherein the step of processing the audio recording includes exchanging information or knowledge between the plurality of selected expert audio agents.

20. The non-transitory computer-readable medium of claim 19, wherein the LLM facilitates the exchanging of information or knowledge between the plurality of selected expert audio agents.
